(19) United States
(12) Patent Application Publication
(10) Pub. No.: US 2025/0252149 A1
(43) Pub. Date: Aug. 7, 2025

(54) SYSTEM AND METHOD FOR DYNAMICALLY IMPROVING ONLINE VISIBILITY

(71) Applicant: Buyersroad Inc. DBA Experience.com, San Ramon, CA (US)

(72) Inventor: Steven Scott Harris, San Ramon, CA (US)

(21) Appl. No.: 19/042,478

(22) Filed: Jan. 31, 2025

Related U.S. Application Data
(60) Provisional application No. 63/548,732, filed on Feb. 1, 2024.

(51) Int. Cl. G06F 16/958; G06Q 30/02

(52) U.S. Cl. CPC G06F 16/958; G06Q 30/02

(57) ABSTRACT

A system and method to improve online visibility of a business entity operating one or more processors to develop a search rank score. A plurality of categories associated with the search rank score is selected, a vertical business segment associated with the business entity is determined, and a plurality of weights is selected in accordance with the vertical business segment. Each of the plurality of weights is associated with a corresponding one of the plurality of categories. In addition, a plurality of sub-scores is developed, wherein each of the plurality of sub-scores is associated with a corresponding one of the plurality of categories. At least one of the plurality of sub-scores is developed by retrieving information regarding the business entity from a third-party server and evaluating the retrieved information. The plurality of sub-scores are combined in accordance with the plurality of weights to develop the search rank score.

### CROSS-REFERENCE TO RELATED APPLICATION

The present application claims the benefit of priority to Harris, U.S. Provisional Patent Application Ser. No. 63/548,732 (Attorney Docket No. C0663/41075), entitled “Search Rank Score (SRS) System”, and filed Feb. 1, 2024, the entire contents of which are incorporated herein by reference.

### FIELD OF DISCLOSURE

The present subject matter relates to systems and methods for improving web site traffic and more particularly a system and a method to dynamically improve a search engine ranking score associated with visibility of a web site.

### BACKGROUND

A user who wishes to obtain a recommendation for a provider of a product or service such as a manufacturer, retailer, a professional or service provider (real estate agent, mortgage broker, plumber, medical professional, etc.), or other business entity (“business entity”) may query a search engine (e.g., www.google.com, www.bing.com, etc.) to identify one or more business entities able to provide the product/service.

Typically, the search engine may identify a plurality of business entities associated with or that are able to provide the product/service. The search engine may take into consideration various factors associated with each business entity such as, for example, proximity to the user, relevance of the product/service provided by the business entity to that requested by the user, how long the business entity has been operating, reviews provided by previous customers of the business entity, and the like to determine a ranked order in which to present the business entities to the user. Typically, for each such business entity that is a candidate to be presented to the user, the search engine may assign a score value associated with the candidate business entity for each such factor and combine such score values to develop one or more metrics associated with the business entity. In response to the query from the user, the search engine may select a predetermined number of business entities having the highest metrics or business entities having a metric greater than a predetermined value and present a list of the selected business entities to the user. In some cases, the list is sorted in descending order by such metric or score value so that the business entity having the largest metric or score value is displayed in a more prominent position (e.g., at the start of a list, with a distinctive font or other presentation, etc.) than those having lower metric or score values. Thus, improving business practices and/or services and/or other activities that affect the factors considered in the metric used by the search engine may in turn provide the business entity a more prominent position in a search result, and thereby may result in increased traffic to the web site associated with the business entity, and may result in additional opportunities for the business entity to generate revenue.

### SUMMARY

According to one aspect, a system to improve online visibility of a business entity includes one or more processors configured to develop a search rank score associated with the business entity. The one or more processors are configured to select a plurality of categories associated with the search rank score, determine a vertical business segment associated with the business entity, and select a plurality of weights in accordance with the vertical business segment, wherein each of the plurality of weights is associated with a corresponding one of the plurality of categories. In addition, the one or more processors are configured to develop a plurality of sub-scores, wherein each of the plurality of sub-scores is associated with a corresponding one of the plurality of categories. At least one of the plurality of sub-scores is developed by retrieving information regarding the business entity from a third-party server and evaluating the retrieved information. The plurality of sub-scores are combined in accordance with the plurality of weights to develop the search rank score.

According to another aspect, a computer-implemented method to improve online visibility of a business entity includes selecting a plurality of categories associated with a search rank score, determining a vertical business segment associated with the business entity, and selecting a plurality of weights in accordance with the vertical business segment, wherein each of the plurality of weights is associated with a corresponding one of the plurality of categories. The method further includes the steps of developing a plurality of sub-scores, wherein each of the plurality of sub-scores is associated with a corresponding one of the plurality of categories, wherein at least one of the plurality of sub-scores is developed by retrieving information regarding the business entity from a third-party server and evaluating the retrieved information. Further, the method includes the step of combining the plurality of sub-scores in accordance with the plurality of weights to develop the search rank score.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a block diagram of a system to improve online visibility of a business entity in accordance with the present disclosure;

FIG. 2 illustrates a graphical user interface (GUI) generated by the system of FIG. 1 to present information on a computer associated with the business entity;

FIG. 2A illustrates another graphical user interface generated by the system of FIG. 1 to present additional information on the computer associated with the business entity;

FIG. 3 illustrates yet another graphical user interface generated by the system of FIG. 1 to allow a user of the computer associated with the business entity to interactively improve the online visibility of the business entity.

FIG. 4 is a block diagram of the computer device that may implement the system of FIG. 1;

FIG. 5 is a flowchart of steps undertaken by the system of FIG. 1 to develop a search rank score associated with the business entity;

FIG. 6 is a flowchart of steps undertaken by the system of FIG. 1 to allow a representative of the business entity to interactively improve the search rank score associated with the business entity; and

FIG. 7 is a flowchart of steps undertaken by the system of FIG. 1 to develop a sub-score for a category that comprises the search rank score.

### DETAILED DESCRIPTION

Disclosed herein is a system and method to improve online visibility of a business entity. The system and method develop a search rank score (SRS) that is a metric that determines a ranking of the business entity relative to other business entities in same vertical business segment. As discussed in greater detail below, the SRS is developed by analyzing various factors associated with online presence of the business entity. Further, the system allows a representative associated with the business entity to monitor and adjust factors reflected in the SRS and that determine selection of a web site associated with the business entity in search results generated by, for example, an Internet search engine and to dynamically adjust such factors to improve a position of the web site in such search results. Typical search engine optimization (SEO) solutions tend to focus on improving scores used to rank a web site associated with the business entity in accordance with factors such as, for example, scores received on review web sites such as www.yelp.com, www.google.com, and the like, a volume of online visitors of the web site, and the like. However, such SEO solutions may not provide an interactive way for the representative to adjust the online presence of the business entity to determine the effect of such adjustment in the metrics used by the search engine to rank the web site associated with the business entity.

As disclosed in greater detail below, the SRS system disclosed herein assesses and improves specific aspects of the online presence of the business entity to improve a value of a metric associated with the prominence with which the information regarding the business entity is presented in search results, and thereby improve traffic to the web site associated with the business entity. Such specific aspects include completeness of a profile information associated with the business entity, metrics developed from reviews of the business entity posted on one or more review web site(s), frequency and quality of replies to such reviews posted by the business entity, social media presence and integration of the business entity, content of the web site associated with the business entity, and consistency of the information associated with the business entity across various online (e.g., Internet) platforms. Further, the specific aspects used to improve the prominence of the web site of the business entity are evaluated in a context of the vertical market or vertical business segment with which the business entity is associated. For example, aspects important to improve the value of the metric associated with a dentist may be substantially different than the aspects that are important to improve the value of the metric associated with a mortgage broker or a plumber.

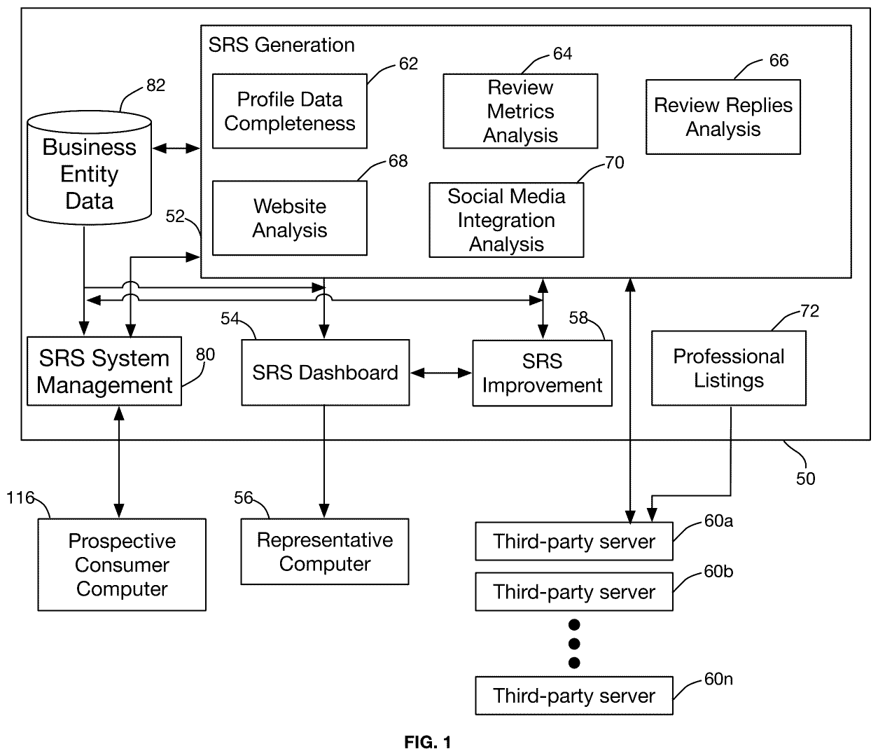

Referring to FIG. 1, a search rank score (SRS) system 50 includes an SRS generation module 52 that generates a metric, i.e., the SRS, for a business entity and an SRS dashboard module 54 that causes a representative computer 56 operated by a representative of the business entity to present one or more graphical user interfaces (GUI) generated by the SRS system 50 in which details associated with the business entity, including the SRS generated by the SRS generation module 52 may be displayed and updated. The SRS system 50 also includes an SRS improvement module 58 that interactively enables the representative of the business entity to adjust the SRS by updating information associated with the business entity in the SRS system 50 and/or using services provided by one or more third-party servers 60a, 60b, . . . and 60n. Such third-party servers 60 may include one or more of, for example, a professional listing service, a social media website (e.g., Facebook, BlueSky, Instagram, etc.), a review aggregation website (e.g., Yelp, Google Reviews, etc.), a business listing aggregator (e.g., Moz Local, Yext, BrightLocal, and etc.), a search engine and map service (e.g., Google, Bing, Apple Maps, Google Maps, etc.) that may influence visibility of the business entity, industry specific directories (e.g., Zillow for real estate, Avvo for legal, Healthgrades for healthcare, etc.) that may contribute to search rank credibility, e-commerce and marketplace platforms (e.g., Amazon, cBay, Etsy, etc.) that may impact the business entity's online reputation and visibility, web analytics and search engine optimization platforms (e.g., Google Analytics, SEMrush, Ahrefs, etc.) that may provide insights into online performance, advertising platforms (e.g., Google Ads, Facebook Ads, LinkedIn Ads, etc.) that can affect online presence and ranking signals, and the like. Such third-party servicers 60 and the like and are typically remote from the SRS system 50.

The SRS generation module 52 further includes a profile data completeness module 62, a review metrics analysis module 64, a review replies analysis module 66, a website analysis module 68, and a social media integration module 70. Each such module 62-70 analyzes a different component of the SRS and generates a score associated with such module. That is, the profile completeness module 62 develops a profile completeness sub-score, the review metrics analysis module 64 develops a review metrics sub-score, and the like. The sub-scores developed by each module 62-70 are combined (e.g., summed, weighted-summed, and the like) to develop the SRS.

The profile completeness module 62 evaluates completeness of the information provided (e.g., via the representative computer 56) for various profile parameters including contact information, specializations, credentials, certifications, and the like to the SRS system 50 and/or one or more third party servers 60 and develops a profile completeness sub-score. In some embodiments, a maximum partial sub-score is associated with each profile parameter and each profile parameter includes one or more types of information associated with the parameter. For each such parameter, the profile completeness module 62 assesses the completeness of the types of information provided for the parameter and associates a partial sub-score value that represents the completeness of such information. For example, the contact information parameter may include information such as a telephone number, email address, a street address, an online handle name, and the like. If the business entity has supplied data for all of the information comprising the contact information parameter, the profile data completeness module 62 may assign the maximum value to the partial sub-score associated with this parameter. However, if incomplete or inconsistent information is provided (e.g., a contact email address is not provided, a zip code does not match a city, etc.), the profile data completeness module 62 may assign less than the maximum value to the partial sub-score associated with the parameter. In some embodiments, each information type of the parameter may have a partial sub-score value associated therewith and the sub-score for the parameter is a sum or a weighted sum of such partial sub-scores (for example, a telephone number may have a higher weight associated therewith than an address). The profile data completion module 62 develops and combines the partial sub-scores for all of the profile completeness parameters in this manner to develop the profile completeness sub-score.

The review metrics analysis module 64 considers both a quantity and quality of reviews posted by customers of the business entity over a particular duration of time (e.g., 12 months) and develops a review metrics sub-score, wherein a higher review metrics sub-score reflects, for example, a greater quantity of substantially positive recent reviews compared to fewer, less positive, and/or older reviews. The review metrics analysis module 64 considers a count of reviews. The impact of the count of reviews on the review metrics sub-score may vary based on the industry or vertical business segment associated with the business entity because some industries (e.g., hospitality, personal services, etc.) tend to be reviewed more often than other industries (e.g., construction, business-to-business services, etc.). Further, the review metrics analysis module depreciates a value of a review over time so that older reviews contribute less to the review metrics sub-score than newer reviews. Again, the rate of such depreciation varies in accordance with the industry associated with the business entity.

The review replies analysis module 66 assesses a frequency and quality of responses by the business entity to reviews posted by customers of the business entity and develops a review replies sub-score. In particular, the review replies analysis module 66 considers a number of replies to reviews within specific timeframes. The impact of replies on the review replies sub-score also depreciates over time. In some embodiments, the rate of depreciation used by the review replies analysis module 66 may be faster than the rate of depreciation used by the review metric analysis module 64 so that recent interactions have a greater impact on the review replies sub-score than older interactions.

The website analysis module 68 analyzes the HTML structure and content of the professional website for relevance and authenticity and develops a website sub-score. The presence and quality of different aspects of the content such as the name, address, and phone number of the business entity, quality of the descriptive content, and the like contribute to the website analysis sub-score.

The social media integration analysis module 70 evaluates how well social media accounts associated with the business entity are connected to, for example, other entities in the same industry, customers, and the like and develops a social media integration sub-score. In addition, frequency and quality of posts made by the business entity, and frequency and quality of social interactions undertaken by the business entity are evaluated by the social media integration module 70 to develop the social media integration sub-score. The contribution of such posts and interactions to the social media integration sub-score may vary depending on relevance of the social media platform on which such posts and interactions are made.

The SRS generation module 52 combines the profile completeness sub-score, the review metrics sub-score, the review replies sub-score, the website sub-score, and the social media integration sub-score to develop the SRS for the business entity. The SRS may be a weighted sum of the profile completeness sub-score, the profile completeness sub-score, review metrics sub-score, the review replies sub-score, the website sub-score, and the social media integration sub-score generated by the profile completeness module 62, the review metrics analysis module 64, the review replies analysis module 66, the website analysis module 68, and the social media integration analysis module 70, respectively. In some embodiments, the weights associated with each such sub-score may vary in accordance with the vertical business segment associated with the business entity. For example, a mortgage loan officer may require fewer reviews whereas detailed profile accuracy and replies to reviews may be considered more important. Thus, the review-metrics sub-score may have a lower weight associated therewith compared to the weights associated the profile completeness sub-score and review replies sub-score may. As another example, frequent reviews, rapid replies, and consistent social media engagement may all have similar importance to the SRS associated with a dentist. Therefore, similar weights may be applied to the review metrics sub-score, the review replies analysis sub-score, and the social media engagement sub-score when the SRS for the dentist is calculated. Further, a plumber may require proximity and emergency responsiveness and, thus, the weight applied to profile completeness sub-score may be higher than the weights applied to other sub-scores when the SRS for the plumber is calculated. As discussed above, in some embodiments, the parameters used to calculate the partial sub-scores that are combined to determine a sub-score generated by the module 62-70 may also have weights associated therewith and such weights may vary in accordance with the vertical business segment associated with the business entity.

The SRS system 50 also includes a professional service listing module 72 that aggregates the profile data provided by the business entity, information provided on the website associated with the business entity, and the social media connections of the business entity and updates information on the third-party servers 60 associated with search engines (e.g., Google), professional directories and listing services (e.g., LinkedIn), social media platforms, and the like to ensure consistency of the information provided by such third-party servers 60 to prospective customers, which in turn may result in improved search engine optimization and online visibility of the business entity.

The SRS system 50 further includes an SRS system management module 80 that periodically invokes the modules 62-70 that comprise the SRS generation module 52 to query the third-party servers 60 (e.g., via application programming interfaces (APIs) associated with such third-party servers 60, a web page scraping application, and the like) to obtain information regarding the business entity used to update sub-scores associated with the SRS, update the SRS associated with the business entity, and store the obtained information and the updated sub-scores and the SRS in a business entity data store 82. In some embodiments, each of the profile completeness module 62, review metrics analysis module 64, review replies analysis module 66, website analysis module 68, and social media integration analysis module 70 analyzes the data provided by the third-party servers 60 and develops and stores the results of such analysis to affect the sub-score developed by the module in the business entity data store 82.

In some embodiments, one or more modules 62-70 may provide store data (e.g., obtained from the third-party modules 60) in the business entity data store 82 used to calculate the sub-score associated therewith and the SRS improvement module 58 may use such stored data to develop a plurality of specific recommendations (or action items) to present to the representative of the business entity to improve the SRS of the business entity. For example, some recommendations may be based on predefined rules and recommend predetermined text the representative of the business entity should incorporate. Other recommendations may be generated using, for example, an AI system such as a large language model (e.g., ChatGPT developed by OpenAI and the like). For example, a review including the review text, a rating, reviewers name, name of the recipient of the review, transaction information, and the like may be presented as an input to AI system and the AI system may generate text that may be an appropriate reply to such review. The representative of the business entity may use the generated text in a reply response to the review as suggested or after being modified by the representative. In some embodiments, the AI system may be integrated with the SRS improvement module 82 to automatically generate and post a response to certain types of reviews and/or automatically implement other recommendations on behalf of the business entity. The SRS improvement module 58 may comprise an artificial intelligence system or a machine learning system incorporated therein (e.g., a neural network or other machine learning system, a decision tree, an expert system, and the like), a predictive analysis system, and/or a rules engine to determine such changes to improve the sub-scores associated with the business entity as determined by the modules 62-70 and thereby improve the SRS associated with business entity. The recommendations developed by the SRS improvement module 58 may also be stored in the business entity data store 82.

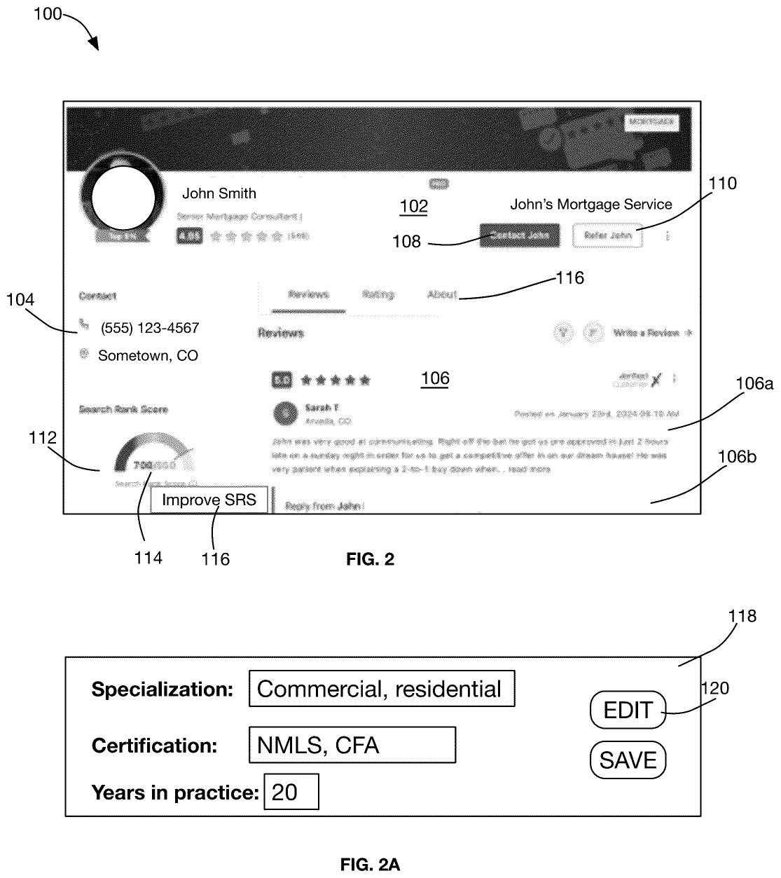

FIG. 2 shows a graphical user interface 100 of a dashboard generated by the SRS dashboard module 54 on the computer 56 used by the representative of the business entity. The user interface 100 includes, for example, an identification region 102 in which identification information of the business entity is displayed, a contact region 104 in which contact information is displayed, a review region 106 in which reviews 106a and responses to reviews 106b are displayed, a contact button 108 that a user may select to contact (e.g., via email, telephone, social media, etc.) a representative associated with the business entity, a referral button 110 that a user may select to send information regarding the business entity to another user, and the like. As shown in FIG. 1, the contact button 108 and the referral button 110 may be displayed in the identification region 102. The user interface 100 also includes a search rank score region 112 in which a search rank score value 114 associated with the business entity is displayed.

Referring also to FIG. 1A, the user interface 100 further includes an about tab selector 116 that when selected replaces the review region 106 with an interface (118) in which the representative of the business entity may enter profile information (e.g., specializations, credentials and/or certifications, number of years in business, etc.), for example, by selecting an edit button 120.

Referring to FIG. 1, in some embodiments, a prospective consumer may use a prospective consumer computer 116 to search for a business entity to provide a particular product of service. For example, the prospective consumer computer 116 may connect to a web server component of the SRS system management module 80 that allows entry of a search query. The prospective consumer may enter the search query (e.g., “plumber in Chicago, IL”) and the SRS system management module 80 may generate a list of business entities selected from the business entity data store 82 that satisfy the search query. In some embodiments, the SRS system management module 80 sorts the list of business entities in descending order in accordance with the SRS associated with such business entities. In some embodiments, the SRS system management module 80 may provide an API that may be used by an application program (e.g., a search engine) operating on the prospective consumer computer 116 or on one of the third-party servers 60 to submit the search query and in response obtain a listing of one or more business entities that satisfy the search query sorted (i.e., ranked) in descending order by the SRS.

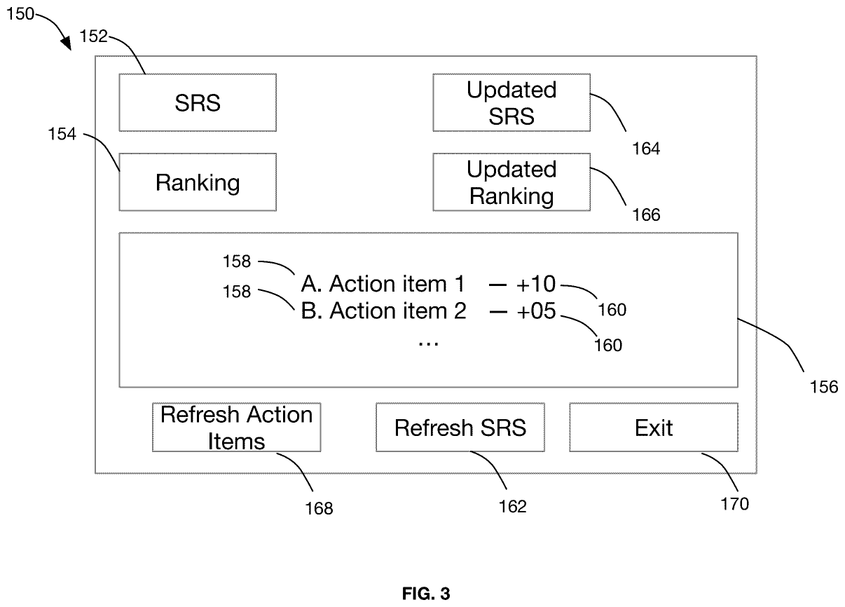

In an embodiment, the SRS system 50 provides a real-time, interactive interface whereby the representative of the business entity may view recommendations generated by the SRS improvement module 58, undertake an action associated with such recommendations, and obtain an indication of the impact on the SRS of undertaking such action. Referring to FIG. 2, selecting a button 116 of the GUI 116 causes the SRS dashboard module 54 to cause the representative computer 56 to present a GUI 150 shown in FIG. 3.

Referring to FIGS. 1 and 3, the GUI 150 includes a region 152 in which the current SRS score associated with the business entity is displayed. The GUI 154 also includes a region 154 in which a rank based on the SRS score of the business entity relative to other business entities in the vertical business segment associated the business entity is displayed. The rank indicates the position of the business entity in the list of business entities generated by the SRS system management module 80 in response to a search query as described above. The GUI 150 also includes a region 156 having a plurality of sub-regions 158 and a corresponding plurality of sub-regions 160. Each sub-region 158 displays an action item generated by the score improvement module 58 and the sub-region 160 associated with such sub-region 158 displays an estimate of a change in the SRS that may be obtained by undertaking the action item. In some embodiments, the SRS dashboard module 54 obtains the information displayed in the regions 152, 154, and 156 from the business entity data store 82. If the user selects one of the sub-regions 158 associated with an action item, detailed instructions regarding such action item may be displayed. Such instructions may include, for example, adding information to the profile associated with the business entity, submitting a reply to a review posted by a user of the business entity on a review website, a change to the information displayed on a page of the website associated with the business entity, and the like. Such instructions may also include one or more hyperlinks and the like that may be followed to undertake the action item. Undertaking such action item may involve the representative of the business using the representative computer 56 (or another computer) to access one or more third-party servers 60 and updating information (e.g., website information, replying to a review, etc.) on such third-party server 60. After undertaking the action item, the representative of the business entity may select a refresh SRS button 162. In response, the SRS dashboard 54 determines the module 62-70 associated with the action item selected by the representative of the business entity, and directs the SRS improvement module 58 to invoke such module 62-70 to generate an updated sub-score, an updated SRS and updated ranking. As discussed above, the invoked module 62-70 stores the updated sub-score (and other related information) in the business entity data store 82 and provides such updated sub-score to SRS improvement module 58, which in turn generates an updated SRS and ranking. In some embodiments, all of the modules 62-70 may be invoked in response to selection of the Refresh SRS button 162. The SRS improvement module stores the updated SRS and updated ranking in the business entity data store 82 and provides such updated SRS to the SRS dashboard module 54, which displays the updated SRS and updated ranking in regions 164 and 166. Thereafter, the representative of the business entity may select another action item 158 to undertake and obtain an updated SRS and updated ranking. Alternately, the representative of the business entity may select a button 168 to refresh the action items. In response, the SRS dashboard module 54 invokes the SRS improvement module 58 to generate revised and/or additional action items that may improve the SRS business entity. The dashboard module 54 displays such revised and/or additional action items and associated score improvement estimates in the sub-regions 158 and 160, respectively. The representative of the business entity may interactively and iteratively use the GUI 150 to improve the SRS of the business entity. The representative may select a button 170 to exit the GUI 150.

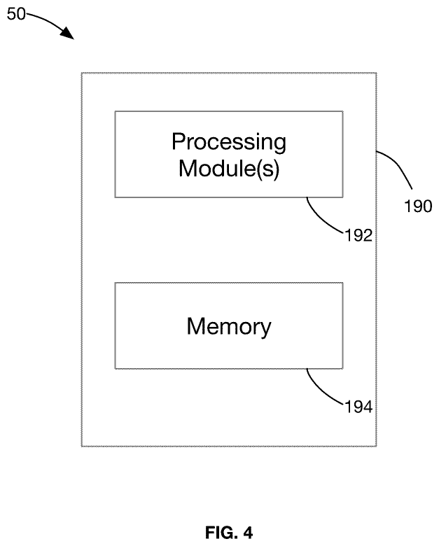

Referring to FIGS. 4, the SRS system 50 may be implemented using hardware, software, firmware, or combinations thereof. In the illustrated embodiment, the SRS system 50 may be implemented by one or more suitably programmed computer-based device(s) 190, some or each having a processing module 192 and a memory 194. The memory 194 has stored therein, among other things, programming instructions executed by one or more processing modules 54, 58, 62, 64, 66, 68, 70, 72, and 80 to cause the components of the SRS system 50 to undertake the functions described herein.

Each computer-based device 190 may comprise, e.g., computer, a device using one or more application specific integrated circuits (ASIC's) and/or field-programmable gate arrays (FPGA's), and/or combinations thereof. Such device 190 may be unitary or may be distributed multiple computing devices, and one or more such computing devices may be installed locally on or remote from other such devices 190. Each computing device 190 may communicate with another computing device over one or more network(s) such as a local area network (LAN), a control area network (CAN), a cellular network, a wide area network (WAN) such as the Internet, and the like. One or more components of the SRS system 50 may be also coupled to and responsive to one or more user device(s) (not shown) such as a keyboard, a mouse, a display, a touchscreen, a joystick, etc. (not shown) via which an operator may monitor and direct operation of the SRS system 50. The GUI's disclosed herein are typically displayed on a conventional display or touchscreen, such as the user devices described immediately above.

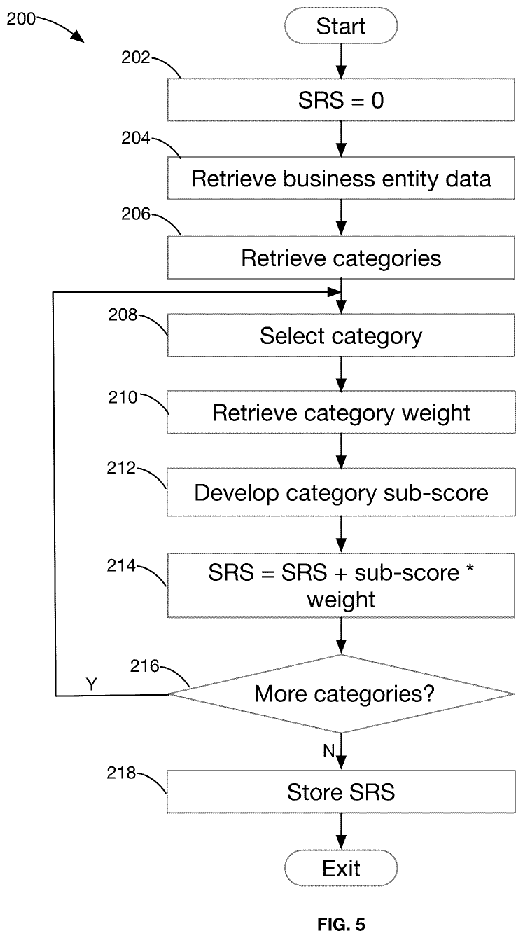

FIG. 5 shows a flow chart 200 of processing undertaken by the SRS generation module 50 to develop the SRS for a business entity. At step 202, the SRS generation module 50 sets a value of the SRS to zero. At step 204, the SRS generation module 50 retrieves information regarding the business entity from the business entity data store 82 including profile information regarding the business entity and the vertical business segment associated with the business entity. At step 206, the SRS generation module 50 retrieves a list of categories (i.e., profile data completeness, review metrics, review replies, etc.) that are evaluated to generate the SRS from the business entity data store 82 or a memory 194 associated therewith. At step 208, the SRS generation module 50 selects one of the categories retrieved at step 206 and at step 210 retrieves a predetermined weight associated with the selected category in accordance with the vertical business segment associated with the business entity. At step 212, the SRS generation module 50 invokes the module 62-70 associated with the selected category to evaluate the online visibility of the business entity in accordance with the selected category and develop a sub-score for the selected category as described in greater detail below. At step 212, the SRS generation module 50 multiplies the sub-score developed at step 212 and the weight retrieved at step 210 and adds the resulting product to the SRS. At step 216, the SRS generation module 50 checks if there are any categories remaining that have not been selected at step 208 and for which a sub-score has not been developed. If there are such categories, the SRS generation module 50 returns to step 208 to select another category. Otherwise, the SRS generation module 50 stores the calculated SRS in the business entity data store 82 and exits.

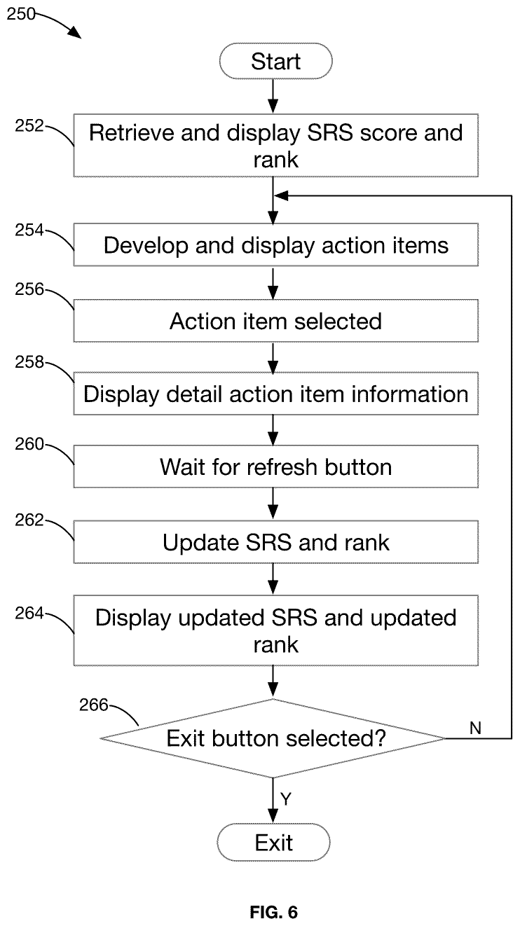

FIG. 6 shows a flowchart 250 of processing undertaken by the SRS system 50 to interactively, iteratively, and in real-time allow the representative of the business entity to improve the SRS score associated with the business entity. Referring to FIGS. 1, 3, and 6, at step 252, the SRS dashboard module 54 retrieves the most recently determined SRS and rank associated with the business entity from the business entity data store 82 and displays such SRS and rank in the regions 152 and 154 of the GUI 150 (FIG. 3). At step 254, the SRS dashboard module 54 invokes the SRS improvement module 58 to analyze the assessment results stored in the business entity data store 82 when the SRS was most recently generated to develop action items that may be undertaken to improve the SRS and an estimate of an improvement in the SRS that may result from undertaking such action item. Also at step 254, the SRS dashboard module 54 displays such action items and improvement estimate in the regions 158 and 160, respectively, of the GUI 150. Such action items may include, for example, a listing of reviews that need replies (or a predetermined number of such reviews), improvements to contents of the web site of the entity and/or loading speed of such web site, social media connections and/or posts that should be made, and the like. At step 256, the SRS dashboard module 54 waits to receive from the representative computer 56 a selection of one of the action items displayed in the region 158. At step 258, the dashboard module 54 displays detailed instructions associated with the selected action item. In some embodiments, the dashboard module 54 may provide an option for the representative to authorize SRS improvement module 58 to undertake the action on the representative's behalf. Such additional details may include a link to a web page hosted on one or more of the third-party servers 60 the representative should access to, for example, update business entity information, reply to a review, and the like. At step 260, the SRS dashboard module 54 waits for the representative of the business entity to select the Refresh SRS button 162. In response to selection of the Refresh SRS button 162, the SRS dashboard module 54 directs the SRS improvement module 58 to invoke the SRS generation module 52 to recalculate the SRS to develop an updated SRS and an updated rank for the business entity. At step 264, the SRS dashboard module 54 displays the updated SRS and updated rank in the regions 164 and 166, respectively, of the GUI 150. In some embodiments, the SRS dashboard module 54 may provide an indication whether the updated SRS and/or updated ranking increased or decreased, an indication of how the updated SRS and rank of the business entity compares to other business entities in the same vertical business segment and/or geographic location, and the like. At step 266, the SRS dashboard module 54 determines if the exit button 170 is selected and if so, the SRS dashboard module 54 exits. Otherwise, the SRS dashboard module 54 returns to step 254 to develop another action list that reflects any changes made by the representative between steps 258 and 260. Further, in alternate embodiments, the SRS dashboard module 82 may develop another action list only after the representative selects the Refresh Action Items button 168. In such embodiments, the SRS dashboard module 82 may proceed to step 256 instead of step 254 after step 266.

FIG. 6 shows a flowchart 300 of processing undertaken by one of the modules 62-70 of SRS generation module 50 to develop the sub-score for the category associated with such module. At step 302, the module 62-70 sets a value of a sub-score associated therewith to zero. At step 304, the module 62-70 retrieves a list of predetermined parameters associated with the category that the module 62-70 evaluates. At step 306, the module 62-70 selects one of the retrieved parameters and at step 304 the module 62-70 retrieves a weight associated with the parameter in accordance with the vertical business segment associated with the business entity. At step 310, the module 62-70 retrieves information associated with the business entity data store and/or from the third-party servers 60 associated with the parameter and assesses the retrieved information. At step 312 develops a partial sub-score in accordance with the assessment developed at step 310. At step 314, the module 62-70 multiplies the partial sub-score developed at step 312 with the weight retrieved at step 308 and adds the product to the sub-score. At step 316, the module 62-70 checks if there are any parameters associated with the category that have not been evaluated and, if so, returns to step 306 to select another parameter. Otherwise, at step 318, the module 62-70 stores the assessments of the business entity information for each parameter developed at step 310, each partial sub-score developed at step 312, and the sub-score developed at step 314 in the business entity data store 82. At step 320, the module 62-70 returns the sub-score to the module (e.g., the SRS generation module 50 or the SRS improvement module 58) that invoked the module 62-70.

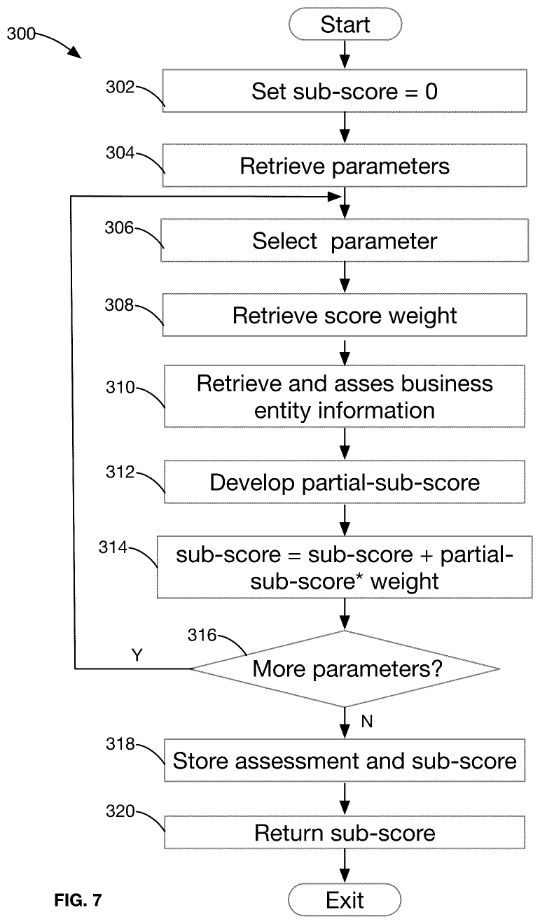

It should be apparent to those who have skill in the art that any combination of hardware and/or software may be used to implement components of the system 50 described herein. It will be understood and appreciated that one or more of the processes, sub-processes, and process steps described in connection with FIGS. 1-7 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules depicted in FIGS. 1-7. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., the SRS generation module 52, the SRS dashboard module 54, the SRS improvement module 58, the profile data completeness module 62, the review metrics analysis module 64, the review replies analysis module 66, the website analysis module 68, the social media integration analysis module 70, the professional listings module 72, and the SRS system management module 80), which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

Depending on certain implementation requirements, the embodiments described can be implemented in hardware and/or in software. The implementation can be performed using a non-transitory storage medium such as a digital storage medium, for example, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according comprise a data carrier having electronically readable control signals, which are capable of cooperating with a processor, a controller, or a programmable computer system, such that one of the methods described herein is performed.

Generally, embodiments disclosed herein can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment, therefore, may include a computer program having a program code for performing one of the methods described herein, when the computer program runs on a processor, a controller, and/or a computer.

A further embodiment of the system described herein is a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitory. A further embodiment of the present invention is an apparatus as described herein comprising a processor and the storage medium.

A further embodiment of the system describe herein is a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

While particular embodiments of the present invention have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A system to improve online visibility of a business entity, comprising:
one or more processors configured to develop a search rank score associated with the business entity to cause the one or more processors to:
select a plurality of categories associated with the search rank score;
determine a vertical business segment associated with the business entity;
select a plurality of weights in accordance with the vertical business segment, wherein each of the plurality of weights is associated with a corresponding one of the plurality of categories;
develop a plurality of sub-scores, wherein each of the plurality of sub-scores is associated with a corresponding one of the plurality of categories, wherein at least one of the plurality of sub-scores is developed by retrieving information regarding the business entity from a third-party server and evaluating the retrieved information; and
combine the plurality of sub-scores in accordance with the plurality of weights to develop the search rank score.

2. The system of claim 1, wherein the one or more processors further analyze the retrieved information to develop an action item, receive an indication the action item has been completed, and develop an updated search rank score in response, wherein developing the action item, receiving the indication, and developing the updated search rank score are undertaken in real time and interactively with a user.

3. The system of claim 2, wherein the action item is developed by one or more of an artificial intelligence system, a neural network or other machine learning system, a decision tree, an expert system, a predictive analysis system, or a rules engine operating on the one or more processors.

4. The system of claim 1, wherein the one or more processors further develop a ranking of the business entity in accordance with the search rank score and a plurality of search rank scores associated with a plurality of business entities associated with the vertical business segment.

5. The system of claim 3, wherein the one or more processors further cause a computer to generate a graphical user interface to display the search rank score and ranking.

6. The system of claim 1, wherein the third-party server is a plurality of third-party servers and the one or more processors further cause the plurality of third-party servers to update information associated with business entity stored thereby so that such information is consistent among the third-party servers.

7. The system of claim 1, wherein a plurality of parameters is associated with each category and the one or more processors develops a plurality of partial sub-scores, wherein each of the plurality of partial sub-scores is associated with a corresponding one of the plurality of parameters, and the plurality of partial sub-scores is combined to develop the sub-score for each category.

8. The system of claim 1, wherein the sub-score for each category is a weighted sum of the partial sub-scores associated with plurality of parameters associated with such category.

9. The system of claim 1, wherein the business entity comprises a first business entity, the vertical business segment comprises a first vertical business segment, and the plurality of weights comprises a first plurality of weights, wherein the one or processors select a second plurality of weights in accordance with a second vertical business segment associated with a second business entity and the first plurality of weights and the second plurality of weights are different.

10. A computer-implemented method to improve online visibility of a business entity, comprising:
selecting a plurality of categories associated with a search rank score;
determining a vertical business segment associated with the business entity;
selecting a plurality of weights in accordance with the vertical business segment, wherein each of the plurality of weights is associated with a corresponding one of the plurality of categories;
developing a plurality of sub-scores, wherein each of the plurality of sub-scores is associated with a corresponding one of the plurality of categories, wherein at least one of the plurality of sub-scores is developed by retrieving information regarding the business entity from a third-party server and evaluating the retrieved information; and
combining the plurality of sub-scores in accordance with the plurality of weights to develop the search rank score.

11. The method of claim 10, further including analyzing the retrieved information to develop an action item, receiving an indication the action item has been completed, and developing an updated search rank score in response, wherein developing the action item, receiving the indication, and developing the updated search rank score are undertaken in real time and interactively with a user.

12. The method of claim 11, wherein developing the action item comprises operating one or more of an artificial intelligence system, a neural network or other machine learning system, a decision tree, an expert system, a predictive analysis system, or a rules engine.

13. The method of claim 11, further including developing a ranking of the business entity in accordance with the search rank score and a plurality of search rank scores associated with a plurality of business entities associated with the vertical business segment.

14. The method of claim 12, wherein further including causing a computer to generate a graphical user interface to display the search rank score and ranking.

15. The method of claim 10, wherein the third-party server is a plurality of third-party servers and further including causing the plurality of third-party servers to update information associated with business entity stored thereby so that such information is consistent among the third-party servers.

16. The method of claim 10, wherein a plurality of parameters is associated with each category further including developing a plurality of partial sub-scores, wherein each of the plurality of partial sub-scores is associated with a corresponding one of the plurality of parameters, and combining the plurality of partial sub-scores to develop the sub-score for each category.

17. The method of claim 10, wherein the sub-score for each category is a weighted sum of the partial sub-scores associated with plurality of parameters associated with such category.

18. The method of claim 10, wherein the business entity comprises a first business entity, the vertical business segment comprises a first vertical business segment, and the plurality of weights comprises a first plurality of weights, further including selecting a second plurality of weights in accordance with a second vertical business segment associated with a second business entity and the first plurality of weights and the second plurality of weights are different.
